(19) United States
(12) Patent Application Publication
(10) Pub. No.: US 2010/0141781 A1
(43) Pub. Date: Jun. 10, 2010

(54) Image capturing device with automatic object position indication and method thereof

(76) Inventor: Tsung Yi Lu, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,473

(22) Filed: Sep. 16, 2009

(30) Foreign Application Priority Data
Dec. 5, 2008 (TW) 97147306

(51) Int. Cl. H04N 5/228; G06K 9/00

(52) U.S. Cl. 348/222.1; 382/107; 348/E05.031

(57) ABSTRACT

An image capturing device with automatic object position indication and the method thereof is provided. The subject invention includes a position indicating module selecting an image-taken position on a display interface of the device. An image recognizing module is included to recognize a displayed position of the image of an object shown on the display interface. Further a processing unit is used to determine a positional difference between the image-taken position and the displayed position, and send a control signal according to the difference to indicate a movement direction that compensates the positional difference. Further an instructing unit is included to output a notice to the object according to the control signal. So that the person can follow the indication and movement toward the predetermined image-taken position and take a perfect photo.

### BACKGROUND OF THE INVENTION

1. Field of the Invention

The present invention relates to an image capturing device with automatic object position indication and the method thereof, in particular, to an image capturing device that automatically indicates the position of a self-shot photographer and the method thereof.

2. Description of Related Art

Most image capturing devices nowadays lack for convenient assistant function of self-photographing. Users have to place their image capturing devices on a stabilizer, and then predetermine a scene and position to be taken. After that, the users go to the desired position and wait for a self-timer. Alternatively the user may hold a shaft attached on the image capturing device and control the device's direction. A mirror that reflects the image shown on the image capturing device's LCD display is another assistant tool for users to adjust their focus.

These mentioned schemes still have problems since the additional tools are needed. The images taken through the tools, such as the mentioned stabilizers, shafts, or mirrors, might be different from the pre-arranged image. It makes those who want to take self-shot picture feel inconvenient. Therefore, a further solution for assisting self-shot photographers is needed to adjust their positions in front of image capturing devices and help them easily take satisfied images. In the meantime, the value of image capturing devices will also be promoted as solving this problem.

### SUMMARY OF THE INVENTION

The present invention provides an image capturing device with automatic object position indication and the method thereof. The device and the method solve the above mentioned inconveniences as adjusting the object's position. Further the invention reaches the goal of taking a perfect picture with a satisfactory composition which the self-shot photographers want.

To achieve the above-mentioned objective, according to one general implementation of the present invention, an image capturing device with automatic object position indication includes a display interface, a position indicating module, an image recognizing module, a processing unit, and an instructing unit.

The position indicating module receives an image-taken position made by a user on the display interface. The image recognizing module recognizes a displayed position of an object shown on the display interface. The processing unit compares the image-taken position with the displayed position to determine a positional difference between the two positions, and generates a control signal based on the positional difference. The control signal is used to instruct a movement direction for the object to compensate the positional difference. The control signal also causes the instructing unit to output a notice for instructing the object to move by the movement direction till the displayed position of the object overlaps the image-taken position. The image of the object is shown on the desired position by this scheme. In the present invention, the object can be a user who wants to take a self-shot photo. The user, i.e. the photographer, can take a picture with desired composition by himself without using any additional tools based on the implementation above.

To achieve the above-mentioned objectives, according to another implementation, the present invention further provides an automatic object position indicating method for an image capturing device, including the following steps: selecting an image-taken position on a display interface of an image capturing device; recognizing a displayed position of an object's image on the display interface; determining whether there exists a positional difference between the image-taken position and the displayed position, and generating a control signal according to the positional difference, wherein the control signal is for instructing a movement direction that compensates the positional difference; and the control signal causing a instructing unit outputs a notice that instructs the object to move by the movement direction. So that the object adjusts the displayed position till it overlaps the image-taken position, and the photographer gets an image with desired composition.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a block diagram of the image capturing device with automatic object position indication according to the present invention;

FIGS. 2A and 2B illustrate the image capturing device with automatic object position indication according to the present invention;

FIG. 3A to 3E illustrate the object's displayed positions; and

FIG. 4 is a flowchart of the automatic object position indicating method of the image capturing device according to the present invention.

### DETAILED DESCRIPTION OF THE PREFERRED EMBODIMENTS

The present invention provides an instructing unit of an image capturing device for instructing an object to move and adjust displayed positions, in order to accurately capture the desired image. For further understanding, please refer to the detailed descriptions below and the drawings.

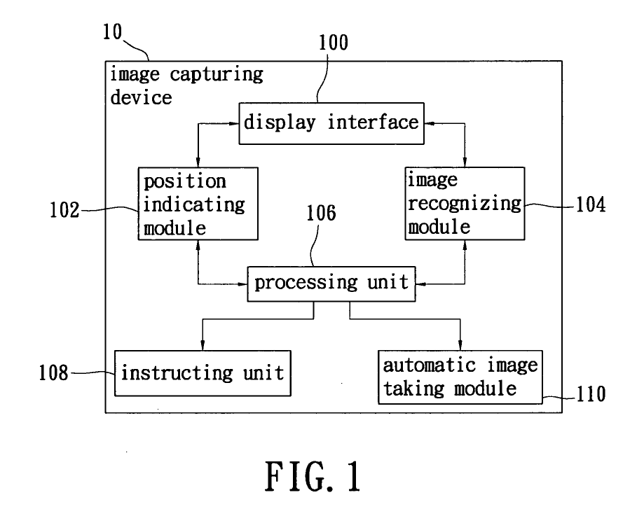

Referring now to FIG. 1, in which a block diagram of the image capturing device with automatic object position indication according to one of the embodiments of the present invention is shown. The image capturing device 10 of the present embodiment includes a display interface 100, a position indicating module 102, an image recognizing module 104, a processing unit 106, an instructing unit 108, and an automatic image taking module 110.

The position indicating module 102 selects an image-taken position on the display interface 100 of the image capturing device 10. The image-taken position is where the user wants an object's image shown within the displaying range of the display interface 100. The object's image in this present embodiment is preferably the user's own image. The image recognizing module 104 recognizes a displayed position of the object where the object's image is shown on the display interface 100. The processing unit 106 compares the image-taken position selected by the position indicating module 102 with the displayed position recognized by the image recognizing module 104, Next, the module 102 determines whether a positional difference between these two positions exists, and generates a control signal based on the determined positional difference. The control signal is then used to instruct a movement direction that is used to compensate the positional difference. The instructing unit 108 sends out a notice based on the control signal, in order to guide the object, i.e. the user, to move in accordance with the movement direction. So that the recognized displayed position of the user changes and becomes closer to the predetermined image-taken position as the user moves, and the user's image finally shows on the predetermined image-taken position.

When confirming no positional difference exists after comparing the image-taken position and the display position, it means that the displayed position of the user is at the image-taken position. In the meantime, the process unit 106 generates the control signal to cause the instructing unit 108 output the notice for notifying the user who is at the right position, and also transmits an activating signal to make the automatic image taking module 110 take the image.

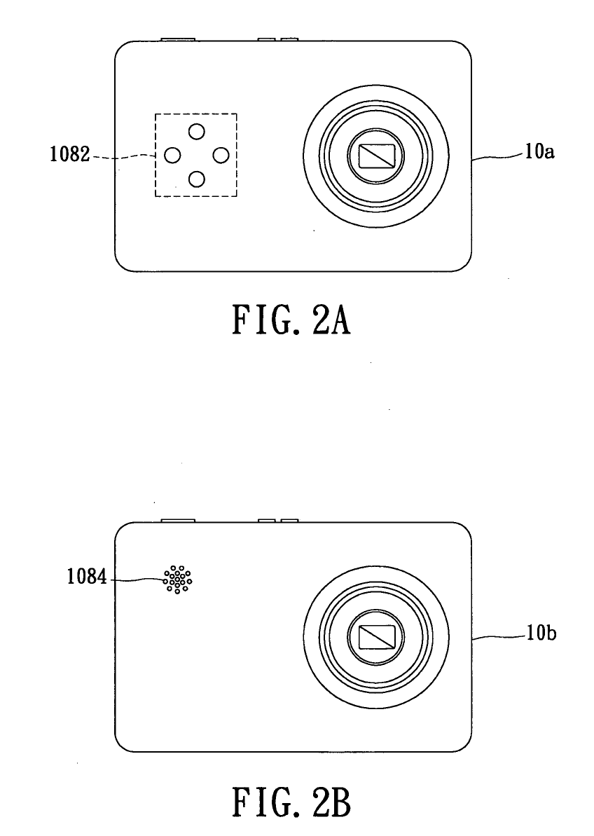

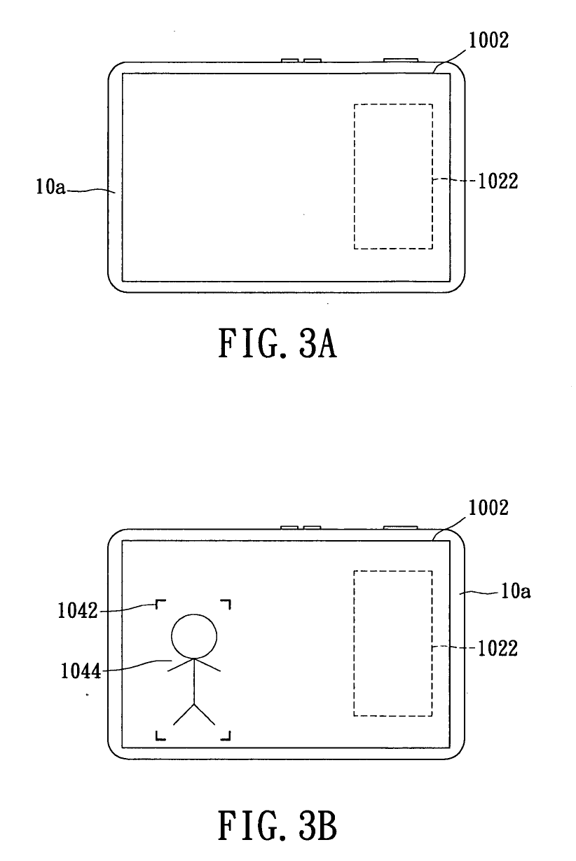

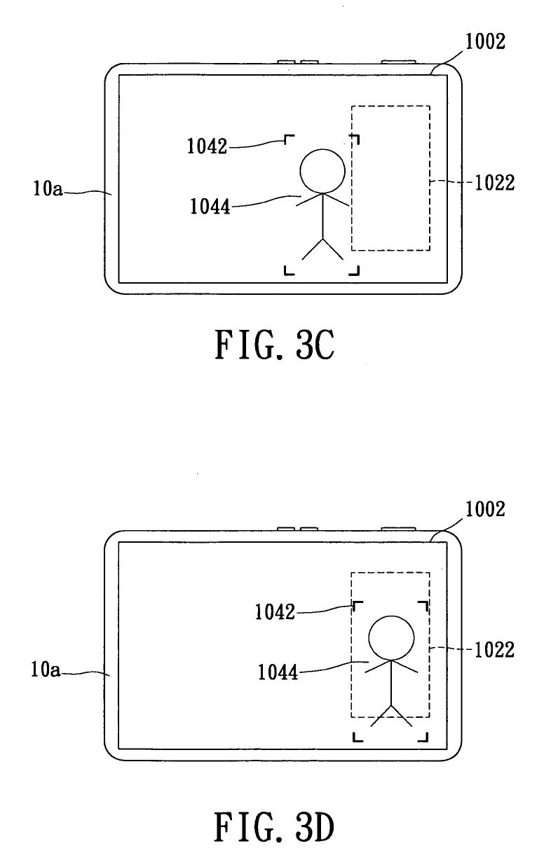

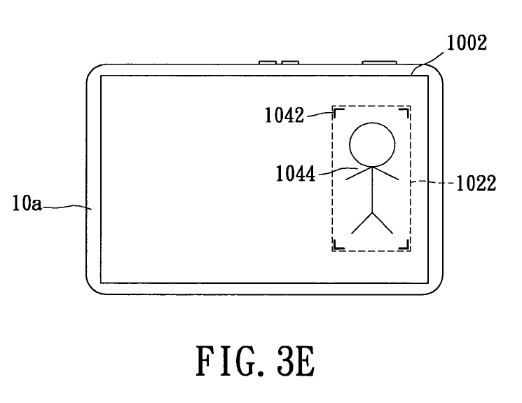

The image capturing device 10 of the present embodiment may be a digital camera or a mobile communication device with photographing function. Therefore, the following description uses a digital camera as an example and refers to the illustrations of FIGS. 2 and 3 for further explanation.

FIG. 2A illustrates a digital camera 10a, wherein the instructing unit 108 of the camera 10a is a light emitting component 1082 located at the surface of the image capturing device 10, i.e. the digital camera 10a of the present embodiment. The light emitting component 1082 instructs the object 1044 to move forward, backward, leftward, or rightward. FIG. 3 illustrates the display interface 100 of the digital camera 10a. As shown in FIG. 3A, the display interface 100 is the display screen 1002 for displaying scenes and previewing images. The position indicating module 102 receives an image-taken position 1022 based on the instruction made by the user (mainly are the object 1044). For example, the user touches the display screen 1002 and outlines a specific range thereon since the display screen 1002 is a touch panel. Next, the position indicating module 102 records the specific range as the image-taken position 1022. Alternatively, the module 102 records a scope having several selected blocks as the image-taken position 1022 since the displaying area of the display screen 1002 can be divided into blocks.

The object 1044 locates in front of the digital camera 10a, wherein the camera 10a receives his/her image through the camera lens to the display screen 1002, as shown in FIG. 3B. The image recognizing module 104 recognizes the displayed position 1042 of the object's 1044 image on the display screen 1002. Due to the well-developed and mature image recognition technique, the skilled in the art can use a variety of hardware, software, or the combination to recognize the mentioned displayed position 1042, therefore, superfluous descriptions are skipped here.

The processing unit 106, such as a digital signal processor (DSP), compares the image-taken position 1022 selected by the position indicating module 102 with the displayed position 1042 recognized by the image recognizing module 104. Next, the processing unit 106 determines the positional difference thereof. Referred to FIG. 3B, for instance, the displayed position 1042 of the object 1044 is determined to be in the left side of the image-taken position 1022 (it would be in the right side from the aspect of facing the lens). Therefore, the control signal for instructing the movement direction that is used to compensate the positional difference is transmitted to the instructing unit 108 and cause the instructing unit 108 outputting a notice relative to the movement direction information. That is, based on the image-taken position 1022, the direction that causes the displayed position 1042 move toward the image-taken position 1022. In this instance, the notice notifies the object 1044 facing the camera lens to move leftward. As shown in FIG. 2A, lighting up the light emitters of the light emitting component 102 which represent four different directions to guide the object 1044 move toward to the image-taken position 1022, for example, lighting up the left emitter to instruct the object 1044 to move leftward or other ways alike.

As the instructing unit 108 of this embodiment may be implemented in the form of light emitters of the light emitting component 1082 that respectively represent different directions as shown in FIG. 2A, it may also be implemented in the form of a speaker 1084 that broadcasts voice messages and guide the object 1044 to move. The voice messages are pre-recorded and stored in the memory (not shown) of the digital camera 10a, as shown in FIG. 2B. Furthermore, in the former light emitting component 1082 example, the amount of the light emitting component 1082 is not limited to be plural. The skilled in the art can easily make modifications according to the disclosure of this embodiment, by using single light emitter, light emitting components and voice messages, or the like.

After the object 1044 moves according to the notice outputted from the instructing unit 108, and the processing unit 106 determines that the displayed position 1042 of the object 1044 is located at the image-taken position 1022 (as shown in FIG. 3E), the processing unit 106 sends out control signal to the instructing unit 108 for notifying the object 1044, e.g. all the light emitting component 1082 lighting up, and further sends out an activating signal to the automatic image taking module 110 for automatically taking the image. Thereby, the user can capture an image with his/her desired composition and scene by his own without asking other people's help or installing any additional tools.

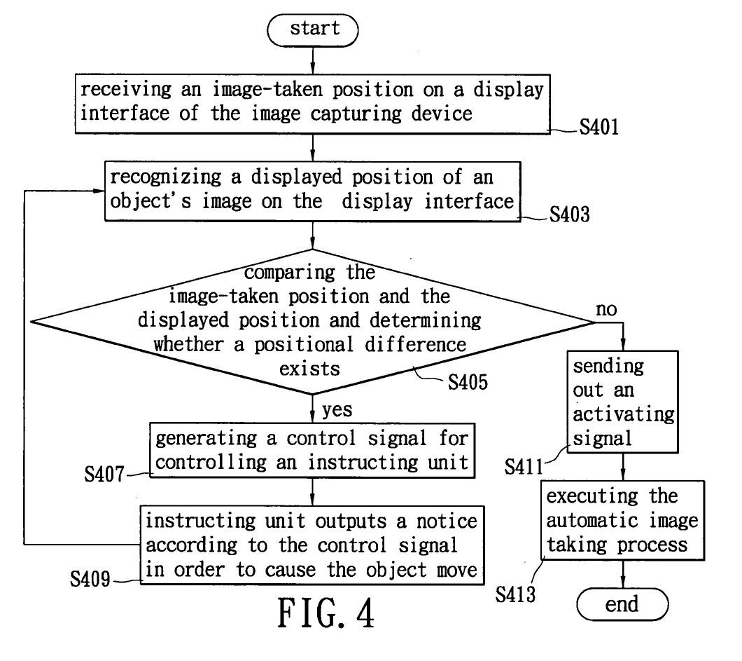

Referring now to FIG. 4, in which a flowchart of the automatic object position indicating method of an image capturing device according to the present invention is shown. Firstly, an position indicating module 102 selects an image-taken position 1022 on the display interface 100 of the image capturing device 10 (S401); an image recognizing module 104 recognizes the displayed position 1042 of an object's 1044 image displayed on the display interface 100 (S403). A processing unit 106 is provided then in order to compare the image-taken position 1022 and the displayed position 1042 on the display interface 100, and to determine whether a positional difference exists between the two positions (S405). If the positional difference exists as shown in FIG. 3B, that the image of the object 1044 is not located at the selected image-taken position 1022, the processing unit 106 will generate a control signal in order to control a instructing unit 108 (S407), wherein the control signal is for instructing a movement direction that compensates the positional difference between the image-taken position 1022 and the displayed position 1042. the instructing unit 108 outputs a notice based on the instruction in the control signal (S409), so as to making the object 1044 move according to the movement direction and adjust the displayed position 1042 of his/her image on the display interface 100.

Though the object 1044 moves toward the image-taken position 1022 based on the instruction of the instructing unit 108, the displayed position 1042 of the image may not identical to the image-taken position 1022 yet. Referred to FIGS. 3C and 3D for example, although the object 1044 moved toward and became closer to the image-taken position 1022, the positional difference still exists. In this situation, the image recognizing module 104 continues to recognizing the displayed position 1042 of the object 1044 (S403). The processing unit 106 then determines whether the positional difference still exists (S405), and make the instructing unit 108 outputs the notice again based on the comparing result for guiding the object 1044 to keep moving. As in FIG. 3C, the processing unit 106 sends the control signal to cause the instructing unit 108 guide the object 1044 to keep moving leftward, and guide he/she to keep moving backward as in FIG. 3D, so as to locate the image of the object 1044 at the image-taken position 1022. Till the positional difference vanishes, i.e. the displayed position 1042 overlaps the image-taken position 1022, as shown in FIG. 3E, the processing unit 106 sends out the control signal to the instructing unit 108 to inform the object 1044, and further sends out an activating signal to an automatic image taking module 110 (S411) to make the automatic image taking module 110 start to take pictures (S413). An image complied with the demand of the user who locates at the predetermined position as the object 1044 is captured.

The image capturing device 10 of the present embodiment may be a digital camera or a mobile communication device with photographing function. Take the digital camera 10a as an example, selecting the image-taken position 1022 in step S401 can be achieved through recording by the position indicating module 102 a selected area of a display screen 1002 as the image-taken position 1022, wherein the display screen 100w is a touch panel and a user touches and circumscribes the selected area. Alternatively, it can be achieved by dividing the display screen 1002 into several blocks and then recording the selected area composed of at least one block by the position indicating module 102.

Besides, the instructing unit 108 of this embodiment can be a light emitting component 1082 with light emitters respectively representing four different directions as shown in FIG. 2A, which instructs the object 1044 to move by lighting up the light emitters. The instructing unit 108 can also be in the form of a speaker 1084 as shown in FIG. 2B that guides the object 1044 via voice messages. Moreover, the instructing unit 108 can be the combination of the above mentioned schemes.

Through determining the positional difference between the image-taken position 1022 with the displayed position 1042 of the object 1044, and controlling the instructing unit 108 to guide the object 1044 to move forward, backward, leftward, or rightward (via light emitting, for example), the object 1044 can finally be located at the predetermined image-taken position 1022. Thus, a simple and useful method for a user taking self-portrait by his/her own without additional tools is provided. Meanwhile, the value of the image capturing device like digital cameras is also increased.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An image capturing device with automatic object position indication comprising:
a display interface configured to display images;
a position indicating module configured to select an image-taken position;
an image recognizing module that recognizes a displayed position of an object's image on the display interface;
a processing unit that compares a positional difference between the displayed position and the image-taken position, and generates a control signal based on the positional difference, wherein the control signal is configured to instruct a movement direction which is used for compensating the positional difference; and
an instructing unit that outputs a notice according to the control signal, and instructs the object to move according to a movement direction, so as to overlap the displayed position and the image-taken position.

2. The image capturing device according to claim 1, wherein the display interface is a touch screen, and the position indicating module selects the image-taken position by recording a user's manipulation on the touch screen.

3. The image capturing device according to claim 1, wherein the display interface is a display screen divided into multiple blocks, the position indicating module selects the image-taken position by recording at least one of the selected blocks.

4. The image capturing device according to claim 1, wherein the instructing unit is a light emitting component configured on the surface of the image capturing device.

5. The image capturing device according to claim 4, wherein the light emitting component outputs the notice via lighting up a light emitter.

6. The image capturing device according to claim 4, wherein the light emitting component further comprising multiple light emitters representing four directions for instructing the object to move forward, backward, leftward, or rightward.

7. The image capturing device according to claim 1, wherein the instructing unit is a speaker.

8. The image capturing device according to claim 7, wherein the speaker outputs the notice via broadcasting a voice message.

9. The image capturing device according to claim 1 further comprising:
an automatic image taking module taking images according to an activating signal, wherein the processing unit transmits the activating signal to the automatic image taking module when the displayed position overlaps the image-taken position.

10. The image capturing device according to claim 1, wherein the image capturing device is a digital camera, or a mobile communication device capable of taking pictures.

11. An automatic object position indicating method of an image capturing device comprising:
receiving an image-taken position on a display interface of the image capturing device;
recognizing a displayed position of an object's image on the display interface;
determining a positional difference between the image-taken position and the displayed position, and generating a control signal according to the positional difference, wherein the control signal is for instructing a movement direction that is used for compensating the positional difference; and
making an instructing unit output a notice based on the control signal, wherein the notice instructs the object to move by the movement direction, so as to overlap the image-taken position and the displayed position.

12. The method according to claim 11, wherein the display interface is a touch screen, and the position indicating module selects the image-taken position by recording a user's manipulation on the touch screen.

13. The method according to claim 11, wherein the display interface is a display screen, and selecting the image-taken position on the display interface further comprises:
dividing the display screen into multiple blocks; and
recording at least one of the selected blocks so as to indicate the image-taken position.

14. The method according to claim 11, wherein the instructing unit is a light emitting component, and the control signal causes the instructing unit output the notice via lighting up a light emitter.

15. The method according to claim 14, wherein the light emitting component further comprises multiple light emitters representing four directions for instructing the object to move forward, backward, leftward, or rightward.

16. The method according to claim 11, wherein the instructing unit is a speaker, and the control signal causes the instructing unit output the notice via broadcasting a voice message.

17. The method according to claim 11, wherein the image capturing device is a digital camera, or a mobile communication device capable of taking pictures.
